(19) United States
(12) Patent Application Publication
(10) Pub. No.: US 2010/0155342 A1
(43) Pub. Date: Jun. 24, 2010

(54) Method for filtering a suspension and filter device

(76) Inventor: Heinz Bonn, Kreuzau-Winden (DE)

Correspondence Address: Friedrich Von Rohrscheidt, 7400 Whitepine Road, Richmond, VA, 23237, US

(21) Appl. No.: 12/653,075

(22) Filed: Dec. 8, 2009

(30) Foreign Application Priority Data
Jun. 8, 2007 (DE) DE102007027033.1
May 27, 2008 (EP) PCT/EP2008/056496

(51) Int. Cl. B01D 25/172; B01D 25/164

(52) U.S. Cl. 210/772; 210/767; 210/227

(57) ABSTRACT

A method for filtering a suspension, the suspension initially being inducted into a filter chamber in a direction which is substantially parallel to at least one filter cloth on a filter cake side of same, the filter chamber being configured substantially lens shaped between two parallel filter plates, when a filter device is closed, whereas when the filter device is open, the filter plates are at such a distance that the at least one filter cloth can be removed from the filter chamber, thereafter a filtrate to permeates the at least one filter cloth to a filtrate side of the filter cloth, wherein a solid content of the suspension is deposited as a filter cake on the filter cake side, and the filtrate subsequently flows out of the filter chamber on the filtrate side. The invention also relates to such a filter device. In order to be able to homogeneously create or wash the filter cake over the filter cloth, the inducted suspension and/or a washing liquid for washing the filter cake on the filter cake side induces an annular flow about a central axis of the filter chamber, said axis being perpendicular to the at least one filter cloth, or the filter device comprises a plurality of induction elements, disposed substantially in a separation plane of the filter plates rotation symmetrical about a center. The suspension or a washing liquid for washing the filter cake can be inducted through the induction elements in an inlet direction, which comprises a radial component oriented towards the center of the filter chamber and a tangential component perpendicular to the radial component.

### RELATED APPLICATIONS

This application claims priority from, and incorporates by reference, International patent application PCT/EP2008/056496, filed on May 27, 2008 and German patent application DE 10 2007 027 033.1, filed on Jun. 8, 2007.

### FIELD OF THE INVENTION

The present invention relates generally to a method and filtering device for filtering a suspension, and more particularly to a method and filtering device for filtering a suspension so as to filter cake more homogeneously over the filter cloth or to wash the filter cake out more homogeneously.

### BACKGROUND

The invention relates to a method for filtering a suspension, the suspension initially being inducted into a filter chamber in a direction which is substantially parallel to at least one filter cloth on a filter cake side of same, the filter chamber being configured substantially lens shaped between two parallel filter plates when a filter device is closed, whereas when the filter device is open the filter plates are at such a distance that the at least one filter cloth can be removed from the filter chamber. Thereafter a filtrate permeates the at least one filter cloth to a filtrate side of the filter cloth, wherein a solid content of the suspension is deposited as a filter cake on the filter cake side, and the filtrate subsequently flows out of the filter chamber on the filtrate side.

The invention also relates to a filter device with at least one filter chamber being configured substantially lens shaped between two parallel filter plates when the filter device is closed, the filter chamber being divided by at least one filter cloth disposed between the filter plates, so that a suspension, which can be inducted on a filter cake side of the at least one filter cloth into the filter chamber substantially parallel to the filter cloth, permeates the at least one filter cloth to a filtrate side of the filter cloth, wherein a solid content of the suspension is deposited on the filter cake side as a filter cake, and the suspension flows out of the filter chamber on the filtrate side, and whereas when the filter device is open the filter plates are at such a distance that the at least one filter cloth can be removed from the filter chamber.

Filter devices, so-called filter presses, with said arrangement of a plurality of filter plates as a plate stack, and filter chambers configured respectively between two adjacent filter plates are generally known as well as said methods to be performed therewith. Depending on the configuration, one or two filter cloths are disposed in the filter chambers substantially in the respective separation plane between adjacent filter plates. Horizontal filter presses with filter plates disposed on top of one another comprise a filter cloth, while vertical filter presses with filter plates hanging next to one another are mostly operated with two filter cloths per filter chamber.

The respective filter cake side of the filter cloths is loaded with a suspension through induction elements, in particular through separate filling shoes, which suspension is loaded with a solid content. The suspension is fed under pressure and pressed through the filter cloth to the filtrate side, wherein the solid load accumulates on the filter cloth as filter cake. The cleaned suspension flows out as a filtrate through an outlet on the filtrate side of the filter cloth or of the filter cloths.

DE 199 56 617 A1 discloses such a filter device with an induction element laterally outside of the filter plane, wherein the suspension is inducted on the filter cake side through the star shaped channels of the induction element. The constant diffuse inflow through these star shaped channels reduces the mechanical loading of the filter cloth, in particular through suspensions with a highly abrasive solid content. Also, filter devices are generally known that have for example, two inlets disposed opposite to one another or four inlets in the corners of the filter chamber, which are substantially oriented towards the center of the filter chamber in order to prevent flows in the side of the chamber.

During operation of the known filter devices, in particular for well filtering products, the solid content of the suspension is deposited in homogeneously over the surface of the filter cloth. This frequently causes plugging in the inlet portion which leads to variable cake thicknesses.

The variable cake thickness causes variable flow resistance and thus variable pressure in the different filter chambers during filtration. Besides the quality deficiency of inhomogeneous filtration power in various filter chambers, these pressure differences load the filter plates and can even cause their destruction.

During subsequent washing of the filter cake, the washing fluid runs in the known filter devices into the filter chamber in a diffuse manner, depending on the type of filter cake, in particular water or oil, as well as, the suspension. At an uneven filter cake, the washing fluid preferably permeates through the areas that are built up less thick.

### SUMMARY OF THE INVENTION

It is an object of the invention to configure the filter cake more homogeneously over the filter cloth or to wash it out more homogeneously.

It is another aspect of the invention to provide a method for filtering a suspension including providing a suspension initially being inducted into a filter chamber in a direction which is substantially parallel to at least one filter cloth on a filter cake side of the at least one filter cloth, the filter chamber being configured substantially lens shaped between two parallel filter plates, when a filter device is closed, whereas when the filter device is open the filter plates are at such a distance that the at least one filter cloth can be removed from the filter chamber. Thereafter a filtrate permeates the at least one filter cloth to a filtrate side of the at least one filter cloth. A solid content of the suspension is deposited as a filter cake on the filter cake side, and the filtrate subsequently flows out of the filter chamber on the filtrate side, and the inducted suspension and/or a washing liquid for washing the filter cake induces an annular flow about a central axis of the filter chamber on the filter cake side, said axis being perpendicular to the at least one filter cloth.

It is another aspect of the invention to provide filter device for filtering a suspension including a filter device with at least one filter chamber being configured substantially lens shaped between two parallel filter plates when the filter device is closed, the filter chamber being divided by at least one filter cloth disposed between the filter plates, so that a suspension, which can be inducted on a filter cake side of the at least one filter cloth into the filter chamber substantially parallel to the filter cloth, permeates the at least one filter cloth to a filtrate side of the filter cloth. A solid content of the suspension is deposited on the filter cake side as a filter cake, and the suspension flows out of the filter chamber on the filtrate side, and whereas when the filter device is open, the filter plates are at such a distance that the at least one filter cloth can be removed from the filter chamber. The filter device includes a plurality of induction elements, disposed substantially in a separation plane of the filter plates rotation symmetrical about a center, through which induction elements the suspension or a washing liquid for washing the filter cake can be inducted in an inlet direction, which includes a radial component oriented towards the center of the filter chamber and a tangential component perpendicular to the radial component. The at least one induction element may be configured in a filling shoe mounted in the filter device.

### BRIEF DESCRIPTION OF THE DRAWINGS

The invention will be described in detail with reference to the following drawings, in which like reference numerals refer to like elements, wherein:

FIG. 1 illustrates a filter plate of a first filter device according to the invention; and

FIG. 2 illustrates a filter plate of a second filter device according to the invention.

### DETAILED DESCRIPTION

Based on the known method, it is proposed according to the invention, that the inducted suspension and/or a cleaning fluid for washing the filter cake induces an annular flow on the filter cake side about a center axis of the filter chamber extending perpendicular to the at least one filter chamber. Such a method according to the invention can be performed in particular by a filter device as described infra and has the following advantages over the prior art.

Based on the known filter device, it is proposed according to the invention to provide a plurality of induction elements disposed in a separation plane of the filter plates rotation symmetrical about the center, through which induction elements the suspension and/or a washing fluid can be inducted in an inlet direction for washing the filter cake, which inlet direction comprises a radial component oriented towards a center of the filter chamber, and a tangential component perpendicular to said radial component. The tangential component of the impulse of the inflowing suspension focused in the substantially uniform inlet direction induces an annular flow in the suspension disposed on the filter cake side. Since the absolute flow velocity of the suspension decreases as a function of the radial distance from the center of the filter chamber, the filter cake is deposited on the filter cloth starting in the center without plugging the suspension inlets.

The filter cake is built up significantly more homogeneously over the entire filtration process through the filter device according to the invention. Thus, the suspension can be filtered in the filtering device according to the invention for longer process duration without partial filter cake formation. The orientation of the induction element according to the invention thus facilitates a much more effective and cost efficient operation of the filter device according to the invention.

Through the subsequent directed inflow, also of the washing fluid, an annular flow is generated in this embodiment, which levels a filter cake with inhomogeneous configuration, thus removes the solid content in the more built-up areas and deposits it again in less strongly built-up areas. Thus, the filter cake is also washed much more effectively through the filter device according to the invention.

The suspension to be filtered and/or the washing fluid flows substantially parallel to the filter cloth into the filter chamber and loads the filter cloth much less than during an inflow through a centrally located inlet. The induction of the suspension and/or of the washing fluid through in particular two or four induction elements disposed rotation symmetrical at the sides of the rectangular filter plate improves the generation and maintenance of the annular flow already at low inlet velocities.

Advantageously, the inlet element is configured in a filling shoe mounted in the filter device. Such a filling shoe can be disposed at the filter plate movable or disengageable. The filling shoe can be comprised of a particularly wear resistant material, which is particularly suited for the inlet, and it can be separately replaced as a wear part.

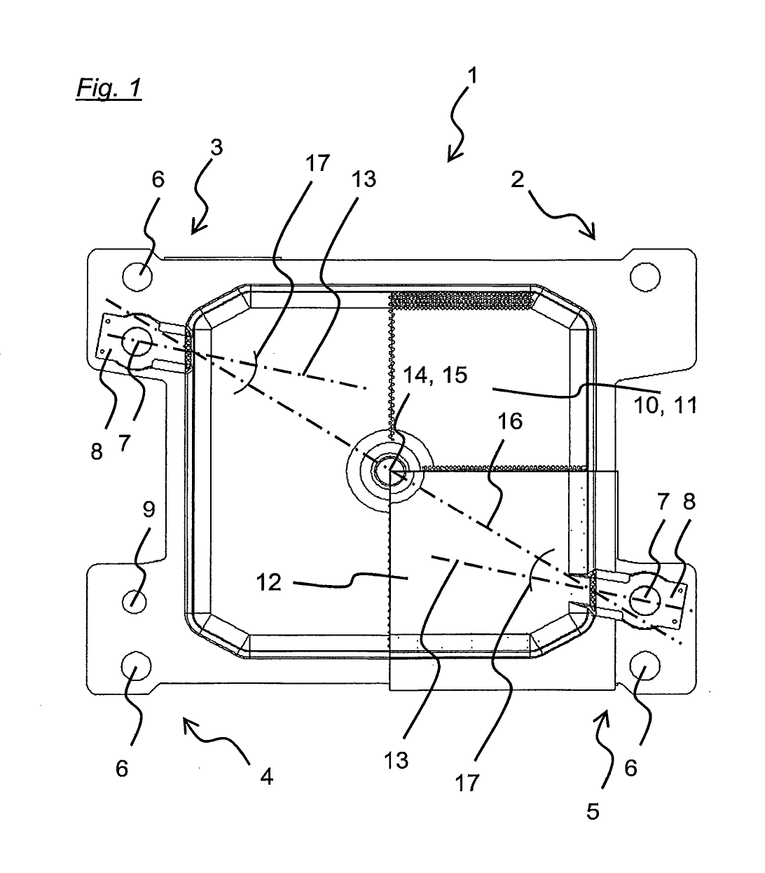

The filter plate 1 made of PP shown in FIG. 1 of a first filter device according to the invention, which is not shown in more detail, includes a substantially square base shape, two load bearing extensions 2, 3 on top and two non-load bearing extensions 4, 5 applied to said base shape. A respective filtrate channel 6 runs through the extensions 2, 3, 4, 5. Furthermore, a respective suspension channel 7 runs through the extension 3 on the top left and through the extension 5 on the bottom right. From this suspension channel, the suspension can be respectively inducted into the filter device through a filling shoe 8. Furthermore, a pressure medium channel 9 runs through the extension piece 4 on the bottom left. The filtrate channels, the suspension channels and the pressure medium channel 9 extend respectively transversal to the filter plate 1 through the filter device.

For mounting the filter device according to the invention, a plate stack of filter plates 1, which is not shown, with upper extensions 2 and 3, is supported at a support frame of the filter device, which is not shown either. The extension 5 at the bottom right is only bolted to the respective filter plates 1 after they have been suspended in the support frame. The remaining extensions 2, 3, 4 are integrally formed respectively with the filter plates 1.

The filter device according to the invention is a so-called membrane filter press with vertically disposed filter plates 1. The illustrated filter plate 1 comprises a chamber side 10 shown in the view in FIG. 1 with a lens shaped recess 11, which forms an enclosed filter chamber in assembled state of the filter device with a respective recess of a membrane side of a second filter plate. Two filter cloths 12 (only one of them is shown) are disposed between the filter plates 1 and extend in parallel thereto. The second filter plate, the recess of the membrane side configured therein, and the assembled state of the filter device are not shown.

In the assembled state of the filter device, a suspension is inducted through the suspension channels through the induction elements 8 configured as filling shoes between the filter cloths 12. The induction elements 8 respectively include a plurality of inlet channels extending parallel to one another in the inlet direction 13, so that the suspension substantially uniformly flows into the filter chamber in this inlet direction 13.

The inlet channels and the inlet direction 13 are not radially oriented towards the center 15 of the filter chamber marked by a support cam 14, but they comprise an angle 17 of approximately 20° relative to the radial direction 16. The impulse of the inflowing suspension and/or washing fluid thus comprises a tangential component perpendicular to the radial direction 16, which tangential component comprises approximately 40% of the entire impulse, which generates an annular flow about the center 15 in the suspension and/or washing fluid between the filter cloths 12.

The suspension and/or the washing fluid permeate the filter cloths 12 during filtering operation respectively on the chamber side 10 and on the membrane side from the filter cake sides to the filtrate sides. Thus, a solid content of the suspension is deposited on the filter cake sides as filter cake and the cleaned suspension as a filtrated and/or the washing fluid flow out through the outlets, which are not shown, into the filtrate channels.

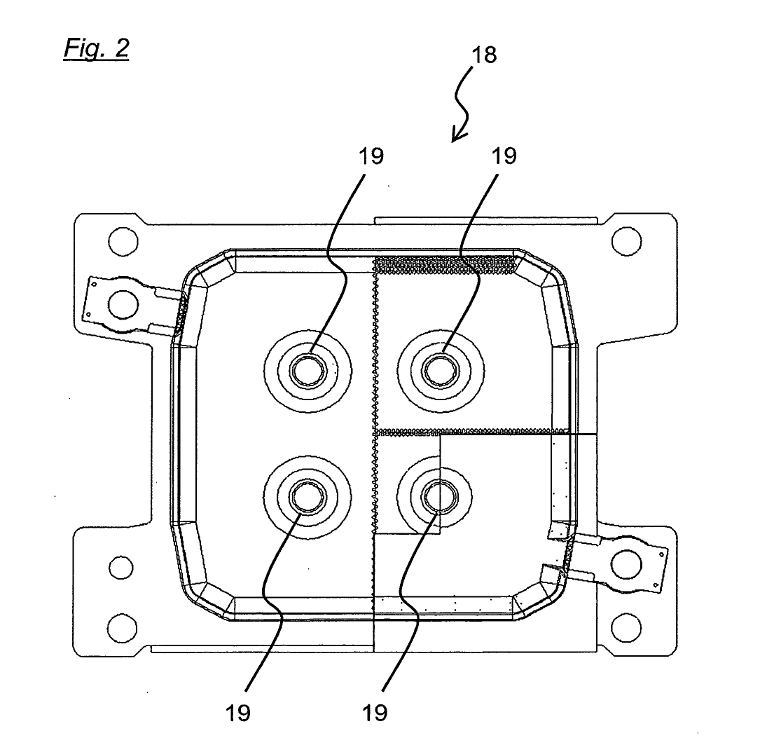

FIG. 2 shows another filter plate 18 of a second filter device according to the invention. The geometry of said filter plate 18, besides comprising four support cams 19, corresponds to the filter plate 1 illustrated in FIG. 1. The filter plate 18 illustrated in FIG. 2 can thus be used at higher process temperatures without excessive distortions in the portion of the filter chamber, or it can be used in larger sizes.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

### REFERENCE NUMERALS AND DESIGNATIONS

1 filter plate
2 extension
3 extension
4 extension
5 extension
6 filtrate channel
7 suspension channel
8 induction element
9 pressure medium channel
10 chamber side
11 recess
12 filter cloth
13 inlet direction
14 support cam
15 center
16 radial direction
17 angle
18 filter plate
19 support cam

What is claimed is:

1. A method for filtering a suspension comprising:
a suspension initially being inducted into a filter chamber in a direction which is substantially parallel to at least one filter cloth on a filter cake side of the at least one filter cloth, the filter chamber being configured substantially lens shaped between two parallel filter plates, when a filter device is closed, whereas when the filter device is open the filter plates are at such a distance that the at least one filter cloth can be removed from the filter chamber, thereafter a filtrate permeates the at least one filter cloth to a filtrate side of the at least one filter cloth,
wherein a solid content of the suspension is deposited as a filter cake on the filter cake side, and the filtrate subsequently flows out of the filter chamber on the filtrate side, and
wherein the inducted suspension and/or a washing liquid for washing the filter cake induces an annular flow about a central axis of the filter chamber on the filter cake side, said axis being perpendicular to the at least one filter cloth.

2. A filter device for filtering a suspension comprising:
a filter device with at least one filter chamber being configured substantially lens shaped between two parallel filter plates when the filter device is closed, the at least one filter chamber being divided by at least one filter cloth disposed between the filter plates, so that a suspension, which can be inducted on a filter cake side of the at least one filter cloth into the at least one filter chamber substantially parallel to the filter cloth, permeates the at least one filter cloth to a filtrate side of the filter cloth,
wherein a solid content of the suspension is deposited on the filter cake side as a filter cake, and the suspension flows out of the at least one filter chamber on the filtrate side, and whereas when the filter device is open, the filter plates are at such a distance that the at least one filter cloth can be removed from the filter chamber,
wherein the filter device includes a plurality of induction elements, disposed substantially in a separation plane of the filter plates rotation symmetrical about a center, through which induction elements the suspension or a washing liquid for washing the filter cake can be inducted in an inlet direction, which includes a radial component oriented towards the center of the at least one filter chamber and a tangential component perpendicular to the radial component.

3. A filter device according to claim 2, wherein the at feast one induction element is configured in a filling shoe mounted in the filter device.
